(19) United States
(12) Patent Application Publication
(10) Pub. No.: US 2009/0202398 A1
(43) Pub. Date: Aug. 13, 2009

(54) Barrier device for withholding odors released by a malodorous substance, particularly for purifying plants

(76) Inventors: Giorgio Micheletti, Sant' Ambrogio Di Valpolicella (IT); Andrea Micheletti, Sant' Ambrogio Di Valpolicella (IT)

Correspondence Address: Bryan A. Santarelli;Graybeal Jackson Haley, 155 - 108th Avenue N.E., Suite 350, Bellevue, WA, 98004-5973, US

(21) Appl. No.: 11/664,854

(22) PCT Filed: Oct. 5, 2005
(86) PCT No.: PCT/EP05/55031

§ 371 Date: Jul. 24, 2008

(30) Foreign Application Priority Data
Oct. 5, 2004 (IT) TO2004A 000669

(51) Int. Cl. B01D 5/00

(52) U.S. Cl. 422/123

(57) ABSTRACT

A barrier device for withholding odors released by a malodorous substance, particularly for purifying plants; the barrier device is provided with a plurality of atomizing nozzles for generating a layer of atomized liquid for covering the free upper surface of the malodorous substance.

### PRIORITY CLAIM

This application claims priority to PCT Application No. PCT/EP2005/055031 filed Oct. 5, 2005, which claims priority to Italian Patent Application No. TO2004A 000669 filed Oct. 5, 2004, which are incorporated herein by reference.

### TECHNICAL FIELD

An embodiment of the present invention relates to a barrier device for withholding odors released by a malodorous substance, particularly for purifying systems.

### BACKGROUND

As it is known, in some treatment and purification steps of sludge and/or sewage, there is the need to abate the unpleasant odors which are released by the substances subjected to treatments and possible stirring actions.

To fulfill this need, it is known to airtightly close the upper part of the tanks which contain the treated malodorous substances.

However, the upper closing of the tanks may be unsatisfactory, because it is relatively complex to make and implies relatively high costs. Such drawbacks are mainly due to the fact that systems are generally necessary for extracting and filtering the gasses which are released by the malodorous substances contained in the tanks to prevent the pressure of the gasses from reaching high levels and creating explosion risks.

Furthermore, in the known solutions, opening the tanks at their top, for example to access the inside for inspecting the substances contained visually and/or for taking possible samples of such substances to be analyzed, is rather long and complex.

U.S. Pat. No. 5,861,096, which is incorporated by reference, discloses a system for controlling odor in industrial lagoons, including a plurality of nozzles adapted to sprinkle or spray a chemically active water solution onto the free surface of the lagoon.

This arrangement is based on the use of chemicals reacting with the odor vapors emanating from the lagoon, rather than on creating a physical barrier which prevents the vapors from spreading in the environment.

This involves costs for the chemicals and for the associated plants. A further problem connected with this system is also the possible diffusion of the chemicals into the environment.

### SUMMARY

An embodiment of the present invention is a barrier device for withholding the odors released by a malodorous substance, particularly for purifying plants, which allows to simply and cost-effectively solve the aforesaid problems.

According to an embodiment of the present invention, there is provided a barrier device for withholding odors released by a malodorous substance, particularly for purifying plants; the barrier device including a side structure surrounding said malodorous substance and delimiting laterally a volume above a free upper surface of said malodorous substance, and atomizing means for generating a layer of atomized liquid extending in said volume above said free upper surface of said malodorous substance so as to completely cover said free upper surface of said malodorous substance and isolate said malodorous substance from an external environment.

### BRIEF DESCRIPTION OF THE DRAWINGS

One or more embodiments of the invention will now be described with reference to the accompanying drawings which show a non-limitative embodiment.

FIG. 1 is a plan view showing a barrier device for withholding odors released by a malodorous substance, particularly for purifying plants according to the present invention.

FIG. 2 shows a section taken along the line II-II in FIG. 1.

FIG. 3 is similar to FIG. 1 and shows, with parts removed for clarity, a variant of the barrier device of FIG. 1.

FIG. 4 shows a section taken along the line IV-IV in FIG. 3.

### DETAILED DESCRIPTION

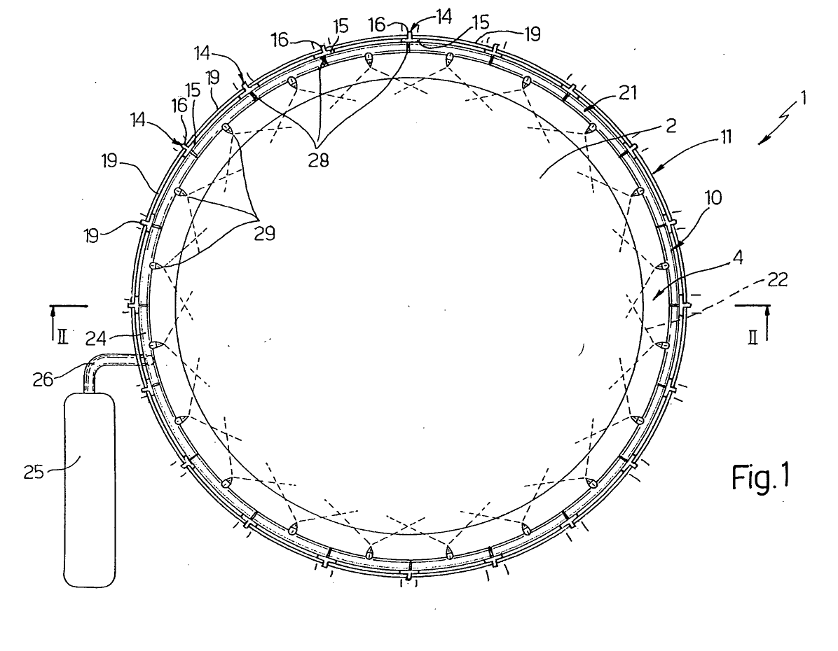

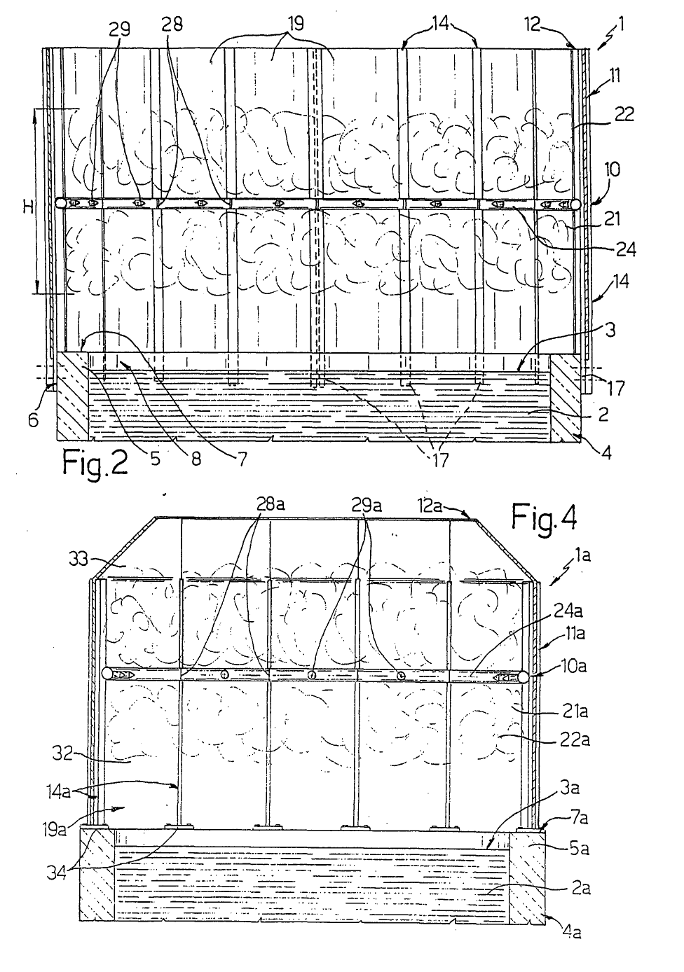

In FIGS. 1 and 2, numeral 1 designates as a whole a tank (partially shown), in particular a tank of a purifying plant (not shown), which contains a malodorous substance 2, for example sludge or sewage treated in such purifying plant, having an upper free surface 3 (FIG. 2) from which gasses and consequent unpleasant odors are released upwardly.

The tank 1 includes a vertical side wall 4 having, in plan, a circular profile and provided with an upper end portion or edge 5 (FIG. 2) which protrudes upwardly with respect to the surface 3 and is defined by an outer cylindrical surface 6, an upper flat surface 7 and an inner cylindrical surface 8.

The wall 4 carries a barrier device 10 which withholds the unpleasant odors released by the surface 3 and includes a cylindrical side structure 11 upwardly extending from and prolonging the wall 4, for example by approximately 2.5 meters.

The structure 11 defines an upper opening 12 and includes a plurality of vertical posts 14, which are defined by respective sectional members with a T cross-section, reciprocally equally spaced apart along the edge 5, and each comprising a respective web 15 and a respective fin 16, reciprocally orthogonal. In particular, the web 15 of each post 14 ends downwards with a segment 17 (FIG. 2) coupled in contact with the surface 6 and integrally connected to the edge 5, so that the surface 7 is left free for the circular advancement path of a possible screen rake carriage (not shown), while the fins 16 are radially facing outwardly.

The structure 11 further includes a plurality of vertical panels 19, which are interposed between the fins 16 of the posts 14, rigidly connected to the pitches 15 and essentially coupled airtightly on the edge 5, in a way not described in detail, at their own lower ends.

The device 10 further includes an atomizer 21, which generates, in use, a layer 22 of atomized liquid, preferably water, in the volume extending above the surface 3 and laterally delimited by the side structure 11, so as to completely cover the surface 3 and isolate the malodorous substance from the external environment.

The atomizer 21 includes a circular manifold 24 which receives pressurized water from a control and feed power unit 25 (schematically shown) through a line 26.

The manifold 24 is housed in the structure 11, coupled with posts 14 in fixed position and spaced apart from the surface 7 by respective securing or fastening devices 28 (schematically shown) and presents a plurality of outlets defined by respective atomizing nozzles 29.

The nozzles 29 are arranged around the periphery of the surface 3, preferably at intermediate positions between the devices 28. The nozzles 29 are directed radially inwards form the manifold 24, in a horizontal direction, are equally reciprocally spaced apart along the manifold 24 and are shaped to generate, under the pressure generated by the power unit 25, the layer 22 which has an adjustable height H, for example between 1 and 2 meters, and is in a vertically spaced apart position from the surface 3, for example by approximately one meter.

The pressure generated by the power unit conveniently ranges between 50 and 150 bar.

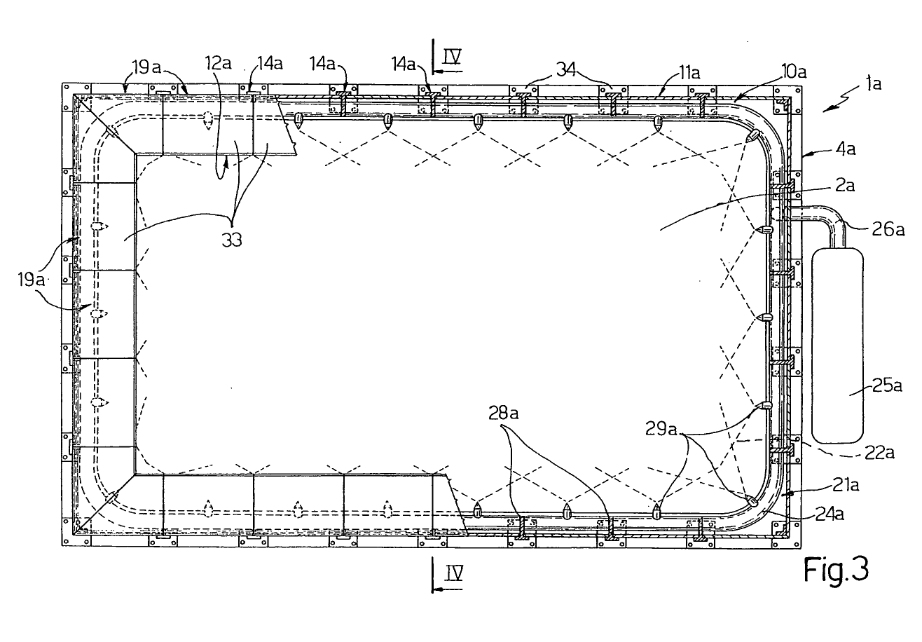

FIGS. 3 and 4 show a variant of the tank 1 and the barrier device 10, in which the components are indicated, where possible, with the same reference numerals used in FIGS. 1 and 2, followed by the reference letter “a”.

Tank 1a differs from tank 1 in that it is rectangular, in plan, whereby also structure 11a and manifold 24a present a substantially rectangular annular shape. Unlike panels 19, panels 19a present respective vertical lower end portions 32 having a height, for example, of approximately 2 meters, and respective upper end portions 33 slanted by approximately 45° with respect to the respective portions 32 reciprocally converging upwardly and towards the centre of opening 12a, and having, for example, a height of approximately 0.5 meters.

Furthermore, unlike the device 10, posts 14a end downwards with respective base brackets 34 resting on and integrally connected to a surface 7a.

In use, atomizer 21, 21a generates the layer 22, 22a, which essentially consists of a “mist” or “cloud” of water droplets which entirely covers surface 3, 3a, defining an upper barrier for unpleasant odors, while structure 11, 11a provides a containment and lateral shielding function for the layer 22, 22a to keep it in stabile conditions also in the presence of wind. The gasses released by the surface 3, 3a are intercepted by the layer 22, 22a before reaching the external environment and, being soluble in water, are absorbed by the droplets of the layer 22, 22a with a high efficiency thanks to the large exchange surface defined by the droplets themselves.

The efficiency of the cover and the unpleasant odor withholding is then increased by the possible presence of the portions 33 slanted or curved towards the centre of the opening 12a.

The droplets of the layer 22, 22a progressively fall by gravity onto the surface 3, 3a, thus contributing to controlling the temperature, and thereby, the stability of the treatment process of the substance 2, 2a. This is because the droplets of the layer 22, 22a are relatively cold and, falling back on the substance 2, 2a, help to keep the temperature in the tank 1, 1a low, for example at approximately 20° C., that is at an optimal temperature for bacterial treatment.

The falling of droplets of the layer 22, 22a onto the substance 2,2a can also contribute to abating the presence of possible foams on the surface 3, 3a.

Advantages of the device 10, 10a are apparent from the operative mode described above.

Moreover, the device 10, 10a allows one to simply and rapidly perform visual inspections inside the tank 1, 1a and/or collect samples of the substance 2, 2a and/or maintenance operations without dismantling any component of the device 10, 10a because the vision and the access inside the tank 1, 1a are not fully obstructed by the layer 22, 22a. When needed to eliminate the layer 22, 22a to perform interventions in the tank 1, 1a, it will simply suffice to deactivate the feed of power unit 25.

The device 10, 10a allows the use of plain water which can be taken also from a well or river, or be recycled water.

Furthermore, the manifold 24, 24a makes the jet of the various nozzles 29, 29a and thereby the layer 22, 22a essentially uniform. Also, the atomizer 21, 21a is relatively simple.

Finally, from the foregoing, it is clear that changes and variations can be implemented to the device 10, 10a described without departing from the spirit and scope of this disclosure.

In particular, the manifold 24, 24a may not be annular and/or may be fitted directly on the edge 5, 5a of the wall 4, 4a without additional structures 11, 11a if the surface 3, 3a is relatively low with respect to the edge 5, 5a itself or may be adjustable in height along the posts 14, 14a.

Furthermore, the device 10, 10a may be used for malodorous substances contained not only in tanks but also in “open-air” conveying channels or also in closed tanks. In this respect, it is to be noted that the power needed to feed the atomizer 21, 21a with water is substantially less, e.g. one fifth, than the power required to suck out odor vapors from the tank and have them pass through a filter, i.e., an active carbon filter.

1. A barrier device for withholding odors released by a malodorous substance, particularly for purifying plants; the barrier device including a side structure surrounding said malodorous substance and delimiting laterally a volume above a free upper surface of said malodorous substance, and atomizing means for generating a layer of atomized liquid extending in said volume above said free upper surface of said malodorous substance so as to completely cover said free upper surface of said malodorous substance and isolate said malodorous substance from an external environment.

2. A barrier device as claimed in claim 1, wherein said atomizing means include a plurality of atomizing nozzles distributed along at least part of the periphery of said upper free surface and fed by a pressurized liquid.

3. A barrier device as claimed in claim 2, wherein said atomizing means include a manifold having an inlet and a plurality of outlets defined by said atomizing nozzles.

4. A barrier device according to claim 3, wherein said manifold is annular.

5. A barrier device as claimed in claim 3, wherein said atomizing nozzles are arranged in reciprocally equally spaced apart positions along said manifold.

6. A barrier device according to claim 1, wherein said liquid is water.

7. A barrier device as claimed in claim 3, wherein said atomizing nozzles are directed in a substantially horizontal direction.

8. A barrier device according to claim 1, wherein said atomizing means are configured to generate said layer of atomized liquid in a vertically spaced apart position from said upper free surface (3, 3a).

9. A barrier device according to claim 1, wherein said atomizing means are configured to generate said layer of atomized liquid having a height higher than one meter.

10. A barrier device according to claim 1, wherein by including a tank containing said malodorous substance, said side structure housing said atomizing means and being arranged in prolongation upwardly of a lateral wall of said tank.

11. A barrier device according to claim 10, wherein said side structure includes a lower vertical end portion and an upper end portion slanted with respect to said lower end portion to partially cover said layer of atomized liquid.

12. A barrier device according to claim 10, wherein said side structure includes:
a plurality of posts, whose lower ends are connectable to the side wall of said tank in reciprocally spaced apart positions, and
a plurality of panels interposed between said posts and integrally connected to the posts themselves.

13. A barrier device according to claim 12, wherein said posts are defined by sectional elements having a T cross-section.

14. A barrier device according to claim 12, wherein said atomizing means are carried by said posts.

15. A barrier device according to claim 12, further including connection means for fastening the lower ends of said posts to an external cylindrical surface of the side wall of said tank, leaving free an upper surface of said side wall.

16. A purifying plant comprising a tank for the treatment of sludge and/or sewage, the tank further including a barrier device according to claim 1.
